(19) United States
(12) Patent Application Publication
(10) Pub. No.: US 2026/0011743 A1
(43) Pub. Date: Jan. 8, 2026

(54) SURFACE STRUCTURED INTERPHASE BASED ON PHASE SEPARATION POROUS FILM FOR STABLE LITHIUM METAL ANODE

(71) Applicant: Nano and Advanced Materials Institute Limited, Hong Kong (HK)

(72) Inventors: Qingwen LU, Hong Kong (HK); Soon Yee LIEW, Hong Kong (HK); Jishi YANG, Hong Kong (HK); Wei HUANG, Hong Kong (HK); Yan Lung WONG, Hong Kong (HK); Xinying SUN, Hong Kong (HK); Shengbo LU, Hong Kong (HK); Chenmin LIU, Hong Kong (HK)

(21) Appl. No.: 19/260,319

(22) Filed: Jul. 4, 2025

Related U.S. Application Data
(60) Provisional application No. 63/667,834, filed on Jul. 5, 2024.

(51) Int. Cl. H01M 4/62; H01M 4/02; H01M 4/134; H01M 4/38; H01M 4/66; H01M 10/052; H01M 10/058

(52) U.S. Cl. CPC H01M 4/628; H01M 4/134; H01M 4/382; H01M 4/661; H01M 10/052; H01M 10/058; H01M 2004/021

(57) ABSTRACT

A rechargeable lithium metal battery is provided, including a lithium metal negative electrode, a positive electrode, an electrolyte, a separator, and a cycling performance-enhancing porous polymer film disposed on the lithium metal electrode. The porous polymer film includes polar functional groups and is configured to trap the solid electrolyte interphase (SEI) components formed during battery cycling and retain them within its porous structure for reuse in subsequent cycles. The porous polymer film stabilizes the SEI and enhances cycling performance, enabling the battery to retain at least 90% of its discharge capacity after 500 charge-discharge cycles at a rate of 1C.

### CROSS-REFERENCE TO RELATED APPLICATIONS

The present application claims priority from U.S. provisional patent application Ser. No. 63/667,834 filed Jul. 5, 2024, and the disclosure of which is incorporated herein by reference in its entirety.

### FIELD OF THE INVENTION

The present invention generally relates to lithium metal anode batteries. More specifically, the present invention improves cycling performance for lithium metal anodes through a surface structured interphase.

### BACKGROUND OF THE INVENTION

Lithium batteries have become indispensable in the realm of electrochemical energy storage, playing a pivotal role in modern life by powering portable electronic devices, electric vehicles, and renewable energy systems. Among the various battery technologies, lithium metal batteries (LMBs) have attracted considerable attention due to the exceptionally high theoretical specific capacity and low electrochemical potential of lithium metal, which make it one of the most promising anode materials for achieving next-generation high-energy-density batteries.

Despite these advantages, the practical application of lithium metal anodes (LMAs) is severely hindered by intrinsic challenges. Notably, lithium metal batteries tend to exhibit poor cycling stability, particularly under high current densities or rapid charge-discharge conditions. This issue becomes more critical at practical areal capacity loadings, where conventional lithium metal anodes often fail within 200 cycles, rendering them unsuitable for real-world applications such as electric vehicles or grid-scale energy storage.

Another major concern with LMAs is the formation of lithium dendrites during repeated lithium plating and stripping. These needle-like structures lead to uneven lithium deposition, increased interfacial resistance, internal short-circuiting, and severe safety risks. Additionally, the large volume changes that occur during cycling result in mechanical degradation of the electrode and loss of electrical contact with the current collector or separator. Combined, these effects cause rapid capacity fading and further compromise the cycling lifespan of lithium metal batteries.

Therefore, the present invention addresses these issues with lithium metal anode batteries.

### SUMMARY OF THE INVENTION

To address these issues, the present invention provides a novel surface structured interphase design by disposing a three dimensional (3D) porous film on top of the lithium metal anode for redistributing uniform Li-ion flux and homogenizing Li-metal deposition, achieving homogeneous lithium deposition/stripping, and strengthening cycling performance of the subsequent lithium metal anode battery.

In accordance with a first aspect of the present invention, the present introduces a rechargeable lithium metal battery. Specifically, the rechargeable lithium metal battery includes:
a lithium metal negative electrode;
a cycling performance-enhancing porous polymer film disposed on the lithium metal negative electrode, the cycling performance-enhancing porous polymer film comprising polar functional groups and having:
   pores having an average diameter ranging from 100 nm to 40 microns,
   a porosity between 50% and 90%,
   a thickness between 10 μm and 100 μm,
   a Gurley value lower than 30 s/100 cc, and
   a tensile strength between 0.5 MPa and 5 MPa;
a separator;
an electrolyte; and
a positive electrode.

It is worth noting that the battery retains at least 90% of discharge capacity after at least 500 charge-discharge cycles at a rate of 1C.

In accordance with one embodiment of the present invention, the cycling performance-enhancing porous polymer film is configured to trap detached or dislodged components of the solid electrolyte interphase (SEI) that form during battery cycling, and to retain these components within its porous structure for potential reincorporation into the SEI during subsequent charge-discharge cycles, thereby enhancing SEI stability and improving cycling performance.

The 3D porous film is able to redistribute the local current density, regulate lithium-ion flux, and guide uniform lithium deposition beneath the film. By providing a spatially confined and ion-conductive scaffold, the porous layer effectively homogenizes the plating/stripping behavior of lithium and suppresses dendritic growth. Furthermore, the mechanical robustness and structural elasticity of the 3D framework accommodate the volume changes of the lithium metal during cycling, thus maintaining interfacial integrity and enhancing long-term battery performance.

In accordance with one embodiment of the present invention, the porous polymer film includes one or more of polyvinylidene difluoride (PVDF), poly(vinylidene fluoride-co-hexafluoropropylene) (PVDF-HFP), copolymers of polyacrylonitrile (PAN), polyacrylate copolymers, polystyrene copolymers, polymethyl methacrylate (PMMA) copolymers, polyvinylpyrrolidone (PVP) and its copolymers, polyetherimide (PEI) and its copolymers, polysulfone and its copolymers, polyimide (PI) and its copolymers, polyphenylene sulfide (PPS), polyether sulfone (PES) and its copolymers, polydimethylsiloxane (PDMS) and its copolymers, cellulose acetate (CA), or cellulose.

In accordance with one embodiment of the present invention, the cycling performance-enhancing porous polymer film further includes an additive selected from one or more of carbon nanotubes, vapor-grown carbon fibers, graphene, metal-organic frameworks (MOFs), and conducting polymers.

In accordance with one embodiment of the present invention, the MOF is selected from MOF-808, MOP-17, UiO-66, ZIF-8, ZIF-67, or HKUST-1.

In accordance with one embodiment of the present invention, the conducting polymer is selected from polyaniline (PANI), polypyrrole (PPY), polythiophene, or poly (3,4-ethylenedioxythiophene) (PEDOT).

In accordance with one embodiment of the present invention, the lithium metal negative electrode includes a lithium metal foil laminated on a copper current collector.

In accordance with one embodiment of the present invention, the lithium metal foil has a thickness of 50 μm or less.

In accordance with one embodiment of the present invention, the positive electrode includes one or more of lithium iron phosphate, lithium cobalt oxide, lithium nickel cobalt manganese oxide, lithium nickel cobalt aluminum oxide, spinel type lithium manganese oxide, or spinel type lithium nickel manganese oxide.

In accordance with one embodiment of the present invention, the battery further includes a separator disposed between the negative electrode and the positive electrode.

In accordance with one embodiment of the present invention, the cycling performance-enhancing porous polymer film promotes uniform lithium-ion flux across the electrode surface and mitigates dendritic lithium growth during repeated cycling.

In accordance with one embodiment of the present invention, the trapped detached or dislodged components of the SEI are re-integrated into the SEI layer during subsequent lithiation/delithiation cycles.

In accordance with a second aspect of the present invention, a method of fabricating the aforementioned lithium metal battery is introduced. Particularly, the method includes the following steps:
forming the cycling performance-enhancing porous film by a phase separation technique followed by subsequent drying;
laminating the cycling performance-enhancing porous polymer film onto the lithium metal negative electrode; and
assembling the negative electrode, positive electrode, separator, and electrolyte to form the lithium metal battery.

In accordance with one embodiment of the present invention, the phase separation technique includes depositing a polymer film by depositing a polymer solution onto a substrate followed by immersion into a bath that includes a polymer solvent and a polymer non-solvent.

In accordance with one embodiment of the present invention, the polymer solution has a concentration ranging from 5% to 30%.

In accordance with one embodiment of the present invention, the polymer solvent is selected from one or more of acetone, chloroform, tetrahydrofuran (THF), dimethylformamide (DMF), dimethylacetamide (DMAc), N-Methyl pyrrolidone (NMP), dimethyl sulfoxide (DMSO).

In accordance with one embodiment of the present invention, the polymer non-solvent is selected from one or more of deionized water, ethanol, methanol, glycerin, glycerol, butanol, hexanol, or octanol.

In accordance with one embodiment of the present invention, the wet thickness of the deposited polymer solution on the substrate is 50 to 300 μm.

In accordance with one embodiment of the present invention, the casting temperature of forming the cycling performance-enhancing porous polymer film ranges from 25° C. to 80° C.

In accordance with one embodiment of the present invention, the substrate deposited with the polymer film is exposed at room temperature for 5 minutes to 60 minutes before the immersion.

In accordance with one embodiment of the present invention, the immersion time ranges from 1 hour to 24 hours.

In accordance with one embodiment of the present invention, the substrate is a glass plate, polyethylene terephthalate (PET) film, polyethylene (PE) film, polypropylene (PP) film, or polytetrafluoroethylene (PTFE) film.

### BRIEF DESCRIPTION OF THE DRAWINGS

Embodiments of the invention are described in more details hereinafter with reference to the drawings, in which:

FIG. 1 (prior art) depicts a prior art lithium metal anode with random and uneven deposition and stripping of lithium ions;

FIGS. 2A-2B depict an overview of the process of the present invention, in which FIG. 2A shows the formation of the porous polymer film by phase separation, and FIG. 2B illustrates the process of laminating the porous film onto lithium foil (optionally laminated to a current collector such as a copper current collector);

FIG. 3 depicts the formed porous film on a lithium metal anode to guide a stable cycling performance;

FIG. 4 shows experimental result for the porous film thickness after phase separation and drying;

FIG. 5 shows the Gurley value result for the various porous films;

FIGS. 6A-6B depict the scanning electron microscopy (SEM) of DW5 porous film, in which FIG. 6A is the top surface, and FIG. 6B shows the bottom surface;

FIGS. 7A-7E depicts the characteristics of the porous film incorporating cellulose as additives, in which FIG. 7A is the top surface SEM image, FIG. 7B is the bottom surface SEM image, FIG. 7C shows the cross-section SEM image, FIG. 7D depicts the discharging capacity of the lithium metal battery incorporating cellulose modified porous film, and FIG. 7E illustrates the coulombic efficiency (CE) of the lithium metal battery incorporating cellulose modified porous film;

FIGS. 8A-8D depicts the characteristics of the porous film incorporating carbon nano-tube (CNT) as additives, in which FIG. 8A is the top surface SEM image, FIG. 8B depicts the bottom surface SEM image, FIG. 8C depicts the discharging capacity of the lithium metal battery incorporating CNT modified porous film, and FIG. 8D illustrates the CE of the lithium metal battery incorporating CNT modified porous film;

FIGS. 9A-9D depicts the characteristics of the porous film incorporating graphene as additives, in which FIG. 9A depicts the top surface SEM image, and FIG. 9B depicts the bottom surface SEM image, FIG. 9C depicts the discharging capacity of the lithium metal battery incorporating graphene modified porous film, and FIG. 9D illustrates the CE of the lithium metal battery incorporating graphene modified porous film;

FIGS. 10A-10B depict the tensile test results of the porous films, in which FIG. 10A shows the mechanical strength of different samples, and FIG. 10B shows the mechanical strength of sample DW5 incorporating different additives;

FIG. 11 shows the battery cycling performance comparing lithium metal coin cells using bare lithium anode and those with porous film casted from room temperature solution (DW1, DW5 and DW9);

FIG. 12 shows the battery cycling performance comparing lithium metal coin cells using bare lithium anode and those with porous film casted from a 60° C. solution (DW2, DW4, DW6 and DW8);

FIG. 13 depicts a cross section optical image taken in-operando for a lithium metal cell using bare lithium metal anode, showing the porous lithium deposition structure;

FIG. 14 shows a cross section optical image taken in-operando for a lithium metal cell using DW5 porous film on lithium metal anode, showing the dense and bulky lithium deposition structure;

FIG. 15 depicts the discharge capacity and CE of pouch cells with the porous film integrated with lithium anode;

FIGS. 16A-16B depict the results of X-ray photoelectron spectroscopy (XPS) analysis conducted on battery samples following lithium stripping, in which FIG. 16A corresponds to a sample using bare Cu foil and FIG. 16B corresponds to a sample using Cu foil coated with the porous film DW5;

FIGS. 17A-17B depict the O1s spectra of battery samples following lithium stripping, in which FIG. 17A corresponds to a sample using bare Cu foil and FIG. 17B corresponds to a sample using Cu foil coated with the porous film DW5;

FIGS. 18A-18B depict the N1s spectra of battery samples following lithium stripping, in which FIG. 18A corresponds to a sample using bare Cu foil and FIG. 18B corresponds to a sample using Cu foil coated with the porous film DW5;

FIGS. 19A-19B. depict the S2p spectra of battery samples following lithium stripping, in which FIG. 19A corresponds to a sample using bare Cu foil and FIG. 19B corresponds to a sample using Cu foil coated with the porous film DW5; and

FIG. 20 depicts the mercury intrusion porosimetry data.

### DETAILED DESCRIPTION

In the following description, lithium metal batteries with cycling performance-enhancing porous polymer films and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Lithium metal batteries are known to suffer from poor cycling performance due to various degradation mechanisms occurring at both the cathode and the anode. Cycling performance refers to the battery's ability to sustain repeated charge and discharge cycles while retaining its capacity, efficiency, and structural integrity. Poor cycling performance results in gradual loss of capacity, increased internal resistance, and decreased reliability, ultimately shortening the battery's operational lifespan.

Key degradation mechanisms include structural instability, side reactions, and mechanical stress accumulation. At the anode, one of the most significant issues is the formation of a solid electrolyte interphase (SEI) layer, which results from reactions between lithium metal and the electrolyte. While the initial SEI is necessary to prevent continuous electrolyte decomposition, its uncontrolled growth consumes both active lithium and electrolyte over time. Moreover, due to the inherent volume fluctuations of the lithium anode during cycling, the SEI layer repeatedly cracks and reforms, accelerating lithium and electrolyte consumption. This contributes to capacity fade and increased internal resistance. Generally, the SEI is composed of inorganic (e.g., Li₂CO₃, LiF) and organic compounds formed from electrolyte decomposition.

The thickening and instability of the SEI layer increase internal resistance, reducing the overall energy efficiency and promoting additional heat generation. This heat further accelerates degradation, compounding the problem. Collectively, these issues—capacity loss, increased impedance, and thermal instability—impair battery performance. To address this, current research efforts have focused on developing advanced electrode materials, more stable electrolytes, protective interfacial coatings, and improved battery management strategies.

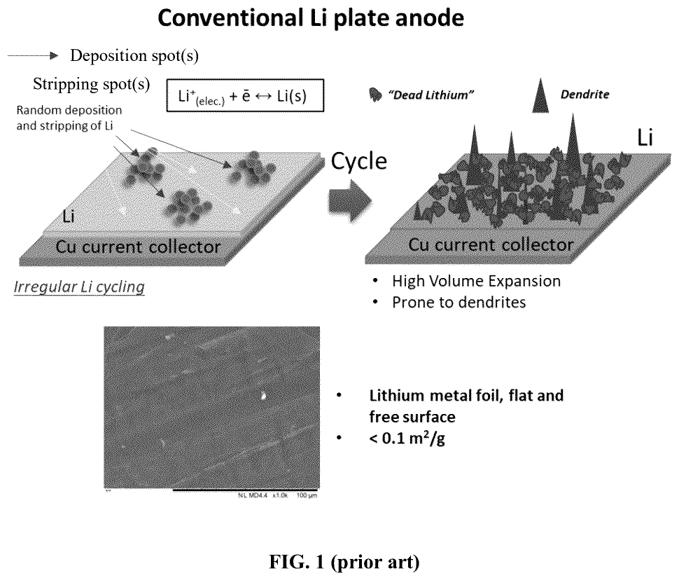

Another major factor contributing to poor cycling performance, especially at a charge-discharge rate of 1C, is the unstable deposition and stripping of lithium metal. As illustrated in prior art (see FIG. 1), non-uniform lithium deposition leads to the formation of dendritic structures instead of smooth, flat lithium layers. These irregular deposits are often induced by localized current density spikes or surface defects. During repeated cycles, such uncontrolled deposition forms high-surface-area lithium (HSAL), while stripping creates isolated “dead lithium,” both of which diminish coulombic efficiency and usable capacity. The accumulation of dead lithium not only wastes active lithium but also accelerates battery degradation. Furthermore, uncontrolled dendrite growth poses a severe safety hazard, as dendrites can penetrate the separator and cause internal short circuits.

In accordance with a first aspect of the present invention, the present invention provides a lithium metal battery with significantly enhanced cycling performance through the integration of a specially engineered porous polymer film applied directly onto the lithium metal negative electrode. This battery design addresses long-standing challenges associated with lithium metal anodes, particularly those related to cycling stability, dendrite formation, and mechanical degradation during charge-discharge cycles.

The lithium metal battery of the present invention comprises a lithium metal negative electrode, a positive electrode, an electrolyte, a separator, and a cycling performance-enhancing porous polymer film disposed on the surface of the lithium metal electrode. The unique porous polymer film significantly improves the performance of the battery. This film is characterized by a porosity between 50% and 90%, which allows for effective lithium-ion transport while maintaining sufficient mechanical integrity. It is worth noting that the pores having an average diameter ranging from 100 nm to 40 microns. The film has a thickness in the range of 10 to 100 microns, ensuring it is robust enough to function as a mechanical barrier while still conformable to the underlying lithium metal surface. Furthermore, it exhibits a Gurley value of less than 30 seconds per 100 cc, indicating excellent gas permeability, which correlates with its open porous structure. The tensile strength of the film falls within the range of 0.5 to 5 MPa, making it flexible enough to accommodate the volume changes of the lithium metal anode during cycling while still providing mechanical resistance against dendrite penetration.

Notably, the porous film contains polar functional groups that enhance its affinity for lithium ions, thereby promoting uniform ion flux across the electrode surface. This uniformity in lithium-ion distribution helps to suppress the formation of dendritic lithium structures and contributes to the stable cycling behavior of the battery.

Additionally, the porous polymer film is capable of trapping decomposition products and fragments of the SEI, which may otherwise lose electrochemical function over successive cycles. During cycling, the native SEI often suffers structural degradation due to its porous, particulate, or brittle nature, and can become mechanically disrupted by the repeated expansion and contraction of the lithium metal electrode. This disruption may lead to disconnection of SEI fragments from the electrode surface, resulting in diminished interfacial protection and reduced functionality. The porous polymer film not only physically retains these detached or degraded SEI components within its structure but also provides mechanical support that facilitates their reincorporation into the SEI in subsequent cycles. Through this mechanism, the porous film reinforces SEI regeneration, stabilizes the interphase, and effectively mitigates irreversible lithium loss and dendrite formation—two of the major challenges limiting the cycling performance of lithium metal batteries.

As a result of this integrated design, the battery is capable of retaining at least 90% of its initial discharge capacity after undergoing at least 500 charge-discharge cycles at a rate of 1C, which is considered a practical benchmark for high-performance rechargeable lithium batteries.

The polymer matrix used in the porous film may be composed of one or more of a wide variety of materials, including PVDF, PVDF-HFP, PAN copolymers, polyacrylate copolymers, polystyrene copolymers, PMMA copolymers, PVP and its copolymers, PEI and its copolymers, polysulfone and its copolymers, PI and its copolymers, PPS, PES and its copolymers, PDMS and its copolymers, CA, or cellulose. These materials provide a balance of mechanical flexibility, thermal stability, and electrochemical compatibility with the lithium metal anode and electrolyte environment.

Additives may be incorporated into the polymer film in order to promote a more uniform deposition of lithium ions. The additives may also lead to creation of a more ordered pore structure by guiding the phase separation process. These additives may include carbon nanotubes, vapor-grown carbon fibers, graphene, MOFs, and conducting polymers. MOFs such as MOF-808, MOP-17, UiO-66, ZIF-8, ZIF-67, or HKUST-1 can be utilized to provide a high-surface-area framework for ion movement and mechanical support. Conducting polymers like PANI, PPY, polythiophene, or PEDOT may be included to facilitate improved electrical pathways within the porous network and enhance interface stability.

Various additional techniques may be employed to create a more ordered porous structure. For high-capacity lithium metal batteries, a more ordered structure for the porous polymer film may be desirable to promote a more uniform lithium deposition. For example, a template may be used to guide the formation of the polymer structure can result in ordered pores. For example, the solution may be cast onto a porous template, which may be hard (for example, formed by hard spheres) or soft (for example, surfactants forming micelles to guide the phase separation and form ordered pores).

Application of a temperature gradient, controlled solvent evaporation rate, electric or magnetic field, and directional flows during casting can form pores in a more ordered manner, creating channel-like structures from coalescence of pores under these external influences.

Phase inversion techniques may also be used to create more ordered structures by controlling the diffusion rates of solvent and non-solvent.

The use of block copolymers can create porous polymer films that self-assemble into ordered nano-porous structures when one of the polymers forming the block copolymer is selectively removed.

The lithium metal electrode typically comprises a lithium foil laminated onto a copper current collector, which serves as a structural support and electron-conducting substrate. In some embodiments, the lithium foil used may have a thickness of 50 microns or less to ensure better energy density and reduced material usage. The positive electrode may be selected from widely used cathode materials such as lithium iron phosphate (LiFePO₄), lithium cobalt oxide (LiCoO₂), lithium nickel cobalt manganese oxide (NCM), lithium nickel cobalt aluminum oxide (NCA), spinel-type lithium manganese oxide, or spinel-type lithium nickel manganese oxide.

A separator is disposed between the negative and positive electrodes to prevent internal short circuits while allowing for ionic transport. The design of the separator and electrolyte may follow conventional standards, but the presence of the engineered porous polymer film on the lithium metal surface is the key innovation that distinguishes this battery system.

The function of the cycling performance-enhancing porous polymer film is to promote a more uniform and stable electrochemical environment during lithium plating and stripping. This is achieved by controlling the local lithium-ion flux at the electrode interface, mitigating current hotspots, and discouraging the nucleation and growth of lithium dendrites. The three-dimensional, polar-functional porous structure also accommodates the volumetric changes of the lithium metal electrode during cycling, thereby improving interface stability and mechanical resilience.

It is worth noting that the trapped detached or dislodged components of the SEI are re-integrated into the SEI layer during subsequent lithiation/delithiation cycles.

The lithium metal battery described herein demonstrates a significant advancement in high-performance rechargeable battery technology by integrating a robust, high-porosity, polar-functional porous film on the lithium metal anode. This integration leads to dramatic improvements in cycle life, safety, and efficiency, thereby enabling broader commercial application of lithium metal batteries in portable electronics, electric vehicles, and grid storage systems.

In accordance with a second aspect of the present invention, a method of fabricating the aforementioned lithium metal battery with enhanced cycling performance is provided. The method begins with the formation of this porous film using a phase separation technique, followed by subsequent drying to solidify the film structure. Once prepared, the porous polymer film is laminated onto the surface of the lithium metal negative electrode. After lamination, the battery is assembled by integrating the negative electrode with a positive electrode, a separator, and an electrolyte, thereby completing the structure of the lithium metal battery.

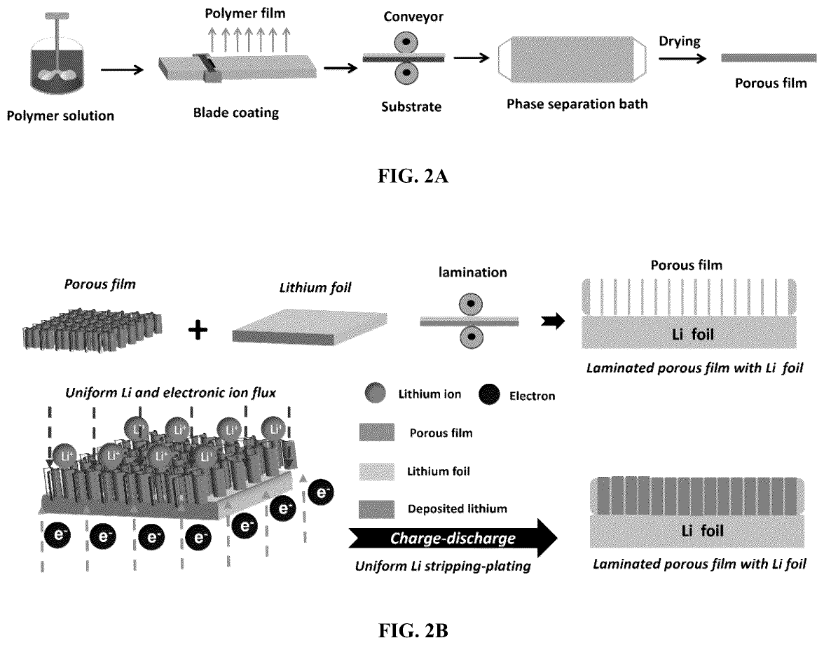

Referring to FIG. 2A, a porous film is formed though phase separation. In FIG. 2B, the porous film is laminated to lithium foil (optionally laminated to a current collector such as a copper current collector). Phase separation provides the polar functional groups and ordered porous channels that guide the lithium ions to form uniform lithium metal deposits. Phase separation involves the separation of a polymer into two distinct phases: a polymer-rich phase and a polymer-poor phase, leading to the formation of a porous structure.

In one preferred embodiment, the porous film is fabricated via a non-solvent-induced phase separation process. This process involves first preparing a polymer solution that is deposited onto a chosen substrate. The deposition may be carried out by casting, doctor blading, or similar coating techniques. After deposition, the coated substrate is immersed into a phase-separation bath comprising a mixture of a polymer solvent and a polymer non-solvent. This immersion initiates the phase separation process that gives rise to a porous structure within the polymer film.

The polymer solution utilized in this process typically has a concentration ranging from 5% to 30% by weight, allowing the viscosity and porosity to be tuned according to desired performance requirements. The choice of solvent for dissolving the polymer is critical for effective film formation and porosity control. Suitable solvents include one or more of acetone, chloroform, THF, DMF, DMAc, NMP, or DMSO. These solvents are selected based on their ability to fully dissolve the selected polymer and exhibit favorable miscibility characteristics with the chosen non-solvent.

The non-solvent, on the other hand, serves to induce phase separation upon immersion. Acceptable non-solvents include deionized water, ethanol, methanol, glycerin, glycerol, butanol, hexanol, or octanol, which are chosen for their immiscibility with the polymer yet miscibility with the solvent, promoting controlled precipitation of the polymer matrix and resulting in a uniform porous structure.

Several processing parameters are also optimized during film fabrication. For instance, the wet thickness of the polymer solution deposited on the substrate typically ranges from 50 to 300 micrometers, with thicker films generally producing larger or more interconnected pores. The casting temperature at which the polymer solution is deposited may range from 25° C. to 80° C., influencing the rate of solvent evaporation and the initial film morphology. Prior to immersion in the non-solvent bath, the cast film may be allowed to stand or partially dry at room or elevated temperature for a period of 5 minutes to 60 minutes—this exposure time affects skin layer formation and final pore structure. The immersion time within the non-solvent bath may vary from 1 hour to 24 hours to ensure complete phase separation and solvent removal.

As the solvent in the polymer film exchanges with the non-solvent from the bath, phase separation occurs. The polymer tends to precipitate out of the solution as the solvent is replaced by the non-solvent. This creates regions of high polymer concentration (polymer-rich phase) and low polymer concentration (polymer-poor phase). The polymer-poor phase forms pores while the polymer-rich phase solidifies, forming the matrix of the film. Immersion time may depend upon the desired porosity of the final structure, with longer immersion times creating more porous final structures.

The substrate upon which the polymer solution is deposited plays a critical role in film adhesion and release. Suitable substrates include rigid and flexible materials such as glass plates, PET films, PE films, PP films, or PTFE films. The choice of substrate depends on the intended method of film transfer and the thermal or mechanical requirements of the downstream lamination process.

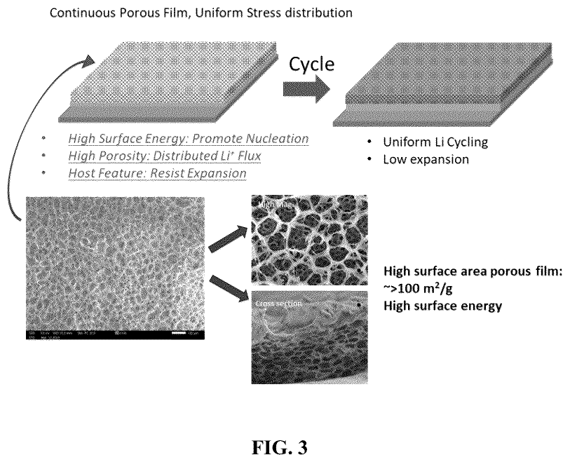

Following phase separation and subsequent drying of all the non-solvent, the porous film may be laminated to a thin lithium metal foil, for example, a lithium metal foil having a thickness of approximately 50 microns or less. The lithium metal foil may optionally be laminated to a current collector, such as a copper current collector. The high surface energy of the formed porous film on the lithium metal anode promotes nucleation, distributes lithium-ion flux and resists expansion during cycling. The porosity creates a high surface area of greater than approximately 100 m²/g as seen in FIG. 3.

Examples of polymers for polymer phase separation and suitable phase separation solvents are listed below:
1. PVDF
Compatible Solvents: DMF, NMP, DMSO, acetone, and THF
2. Polysulfone (PSF)
Compatible Solvents: NMP, Dimethylacetamide (DMAc), DMF, THF, and Dichloromethane (DCM)
3. PES
Compatible Solvents: NMP, DMAc, DMF, THF, and DMSO
4. PAN
Compatible Solvents: DMSO, DMF, and DMAc
5. PMMA
Compatible Solvents: THF, acetone, chloroform, and DCM
6. PI
Compatible Solvents: NMP, DMAc, DMSO, and THF
7. CA
Compatible Solvents: acetone, DMF, THF, DCM, and methanol (when used as a co-solvent)
8. Polyvinyl Alcohol (PVA)
Compatible Solvents: Water (with heating), and DMSO (as a co-solvent with water)
9. PS
Compatible Solvents: Toluene, chloroform, DCM, THF, and benzene
10. Polyethylene Oxide (PEO)
Compatible Solvents: Water, ethanol, methanol, and acetonitrile
11. Poly (lactic-co-glycolic acid) (PLGA)
Compatible Solvents: DCM, chloroform, and acetone
12. Polycaprolactone (PCL)
Compatible Solvents: Chloroform, DCM, THF, and acetone
13. PEI
Compatible Solvents: NMP, DMSO, and DMAc
14. PET
Compatible Solvents: Dichloroacetic acid, phenol/1,1,2,2-tetrachloroethane mixture, and benzyl alcohol (with heat)

### EXAMPLES

### Example 1. Fabricating the Cycling Performance-enhancing Porous Polymer Films

Table 1 lists compositions used in the examples for creating the cycling performance-enhancing porous polymer films. Various polymer weight percentages are used along with different dissolution temperatures. The polymer used is PVDF-HFP, the solvent for the polymer dissolution is a mixture of 90% DMF and 10% water while the polymer non-solvent for the phase separation is water. The wet polymer film is coated by doctor blade method. The wet polymer film after coating is then left to set in air for 30 minutes before immersion in water which is the polymer non-solvent for the phase separation process, followed by drying in vacuum dryer at 60° C. for 24 hours. The conditions varied are weight percentage of the polymer in solution, the dissolution temperature of the polymer solution, substrate material for the polymer film casting, and the wet-coating thickness for the casted film before the phase separation step and drying. From these experiments, the conditions that result in phase separation porous films are established (DW1, DW2, DW4, DW5, DW6, DW8, and DW9), and conditions that do not result in the porous film is also identified (DW3, DW7, and DW10).

TABLE 1

| | PVDF-HFP | | | Coating | |
|---|---|---|---|---|---|
| | weight | Dissolution | | thickness, | |
| Entry | percentage (%) | temperature | Substrate | wet (μm) | Result |
| DW1 | 15 | RT | Glass | 150 | Film |
| DW2 | 15 | 60 | Glass | 150 | Film |
| DW3 | 20 | RT | Glass | 100 | N/A |
| DW4 | 20 | 60 | Glass | 100 | Film |
| DW5 | 15 | RT | PE | 150 | Film |
| DW6 | 15 | 60 | PE | 150 | Film |
| DW7 | 20 | RT | PE | 100 | N/A |
| DW8 | 20 | 60 | PE | 100 | Film |
| DW9 | 15 | RT | PET | 150 | Film |
| DW10 | 15 | 60 | PET | 150 | N/A |

### Example 2. Characteristics and Morphology of the Cycling Performance-enhancing Porous Polymer Films

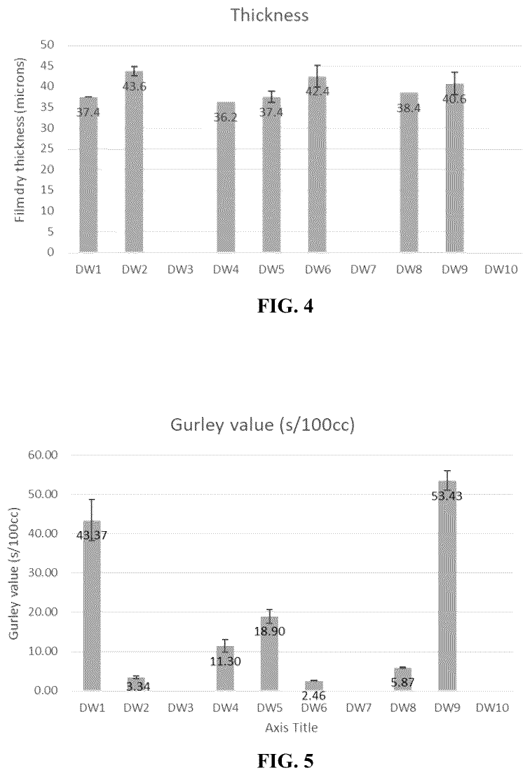

FIG. 4 illustrates the final thicknesses of various porous polymer films fabricated using a phase separation technique. The resulting films exhibit thicknesses ranging from approximately 36 microns to 44 microns. The final thickness of each film is primarily influenced by the initial wet coating thickness used during deposition. It has been observed that adjusting the wet coating thickness results in a corresponding proportional change in the final film thickness, thereby enabling tunability of the membrane's structural profile according to specific design requirements.

FIG. 5 presents the Gurley values of several porous film samples. The Gurley value is a standard metric used to evaluate the gas permeability of porous membranes, measured as the time (in seconds) required for 100 cc of air to pass through the membrane under a specified pressure. A lower Gurley value indicates higher permeability, while a higher value suggests greater resistance to gas flow. The permeability of the porous films is influenced by various structural parameters, including pore size, pore size distribution, and the tortuosity of the pore network. Among the samples tested, films labeled DW1 and DW9 exhibit the highest Gurley values, indicating the poorest gas permeability. In contrast, the film labeled DW6 demonstrates the lowest Gurley value and thus the best permeability performance, reflecting a well-developed porous architecture conducive to fluid and ion transport.

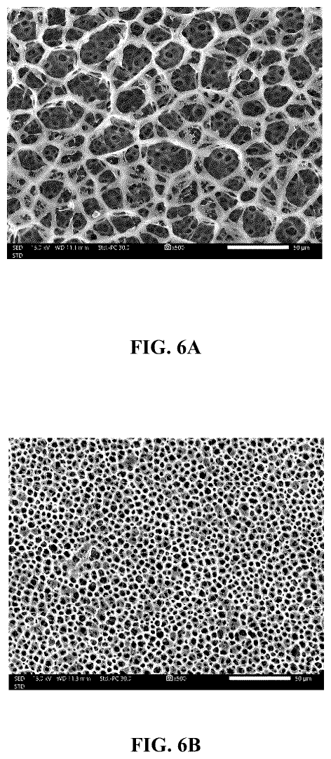

FIGS. 6A and 6B provide SEM images of a representative porous film sample, designated DW5. FIG. 6A shows the top surface morphology, while FIG. 6B shows the bottom surface. The top surface features a pore structure that resembles the morphology typically observed in dense and bulky lithium deposits. Accordingly, this surface is intended to be placed in direct contact with the lithium metal foil during battery assembly, where it facilitates conformal contact and helps regulate lithium deposition. In contrast, the bottom surface displays a more uniform pore size distribution and relatively smaller pore diameters, characteristics that are beneficial for controlling electrolyte transport. When oriented to face the separator, this surface can modulate ion flow from the cathode, thereby supporting a uniform lithium plating process. This dual-surface functional design enables the top surface to effectively accommodate and guide dense lithium growth within its larger pore channels, while the bottom surface promotes consistent ionic conduction from the electrolyte side. Collectively, this architecture supports homogeneous lithium deposition, mitigates dendritic growth, and enhances battery cycling stability.

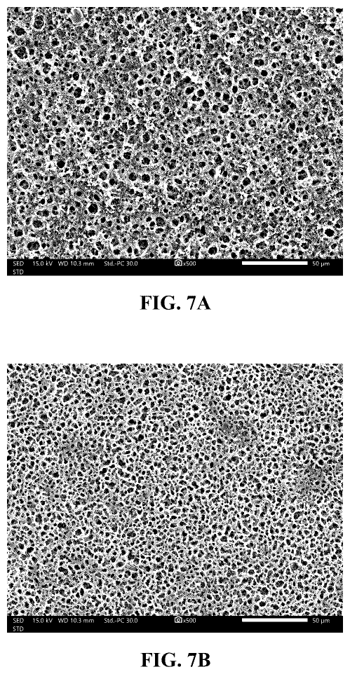

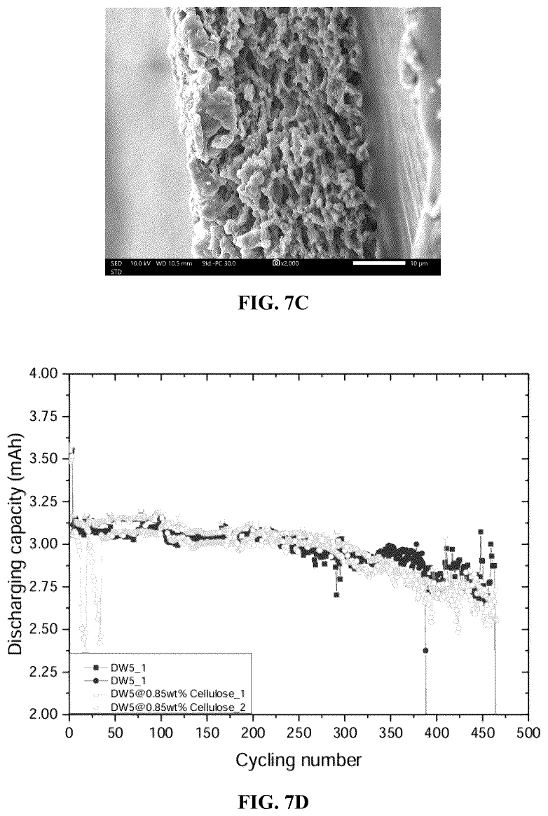

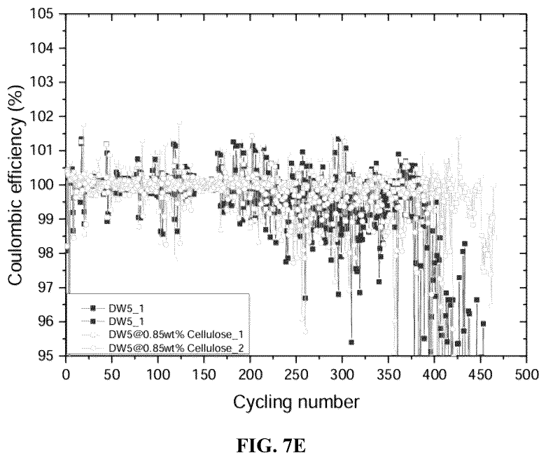

Additionally, the effects of several additives on the structure and morphology of the porous films are evaluated. In one instance, cellulose nanofibers are incorporated as an additive. A polymer slurry modified with 0.85 wt % cellulose is processed into a porous membrane with a thickness of approximately 40 μm, using a film-forming method analogous to that used for DW5. Comparative morphological analysis reveals that the addition of cellulose significantly alters the film structure: both the top and bottom surfaces (FIG. 7A and FIG. 7B) display smaller and more irregularly shaped pores compared to a control film lacking cellulose. These differences are attributed to localized interactions between the cellulose fibers and the polymer matrix during the phase separation process. Cross-sectional imaging (FIG. 7C) confirms a pore-rich internal structure with notably thicker pore walls, suggesting a reinforcement effect from the cellulose.

When integrated with lithium metal and paired with a lithium iron phosphate (LFP) cathode under 1C/1C cycling conditions, the cellulose-modified porous film exhibits an initial capacity retention and capacity decay profile that closely matches that of the baseline DW5 porous film (FIG. 7D and FIG. 7E). This result indicates that the incorporation of cellulose does not significantly alter electrochemical kinetics or hinder lithium transport during cycling.

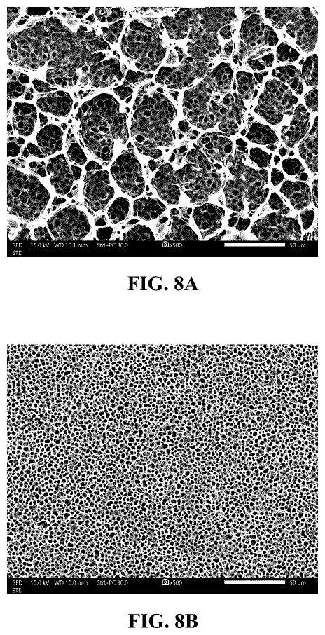

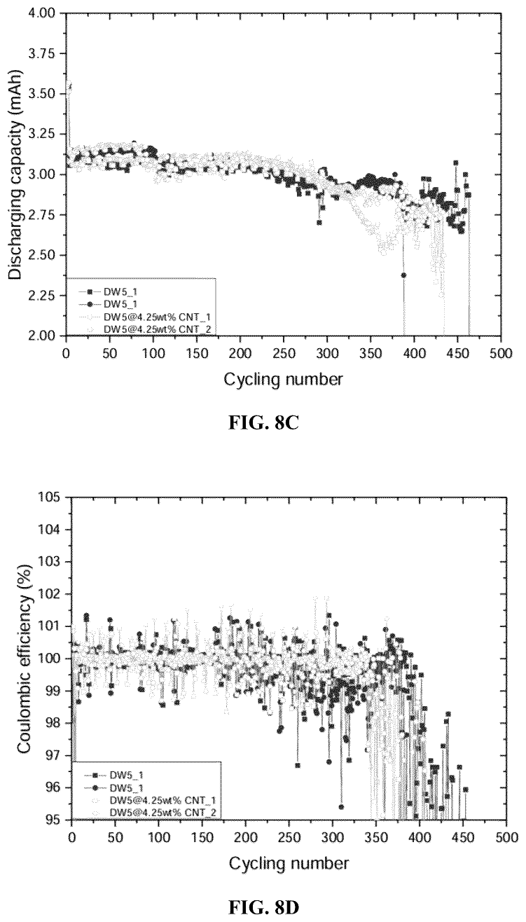

Carbon nanotubes (CNTs) are also investigated as additive candidates. A polymer slurry containing 4.25 wt % CNTs is processed into a porous membrane approximately 40 μm in thickness using the same film-forming methodology. Structural evaluation shows that the addition of CNTs leads to distinct changes in surface morphology: the top surface (FIG. 8A) exhibits a broad distribution of irregular pore sizes, while the internal pore structure remains similar to that of the DW5 porous film. The bottom surface (FIG. 8B), however, presents a reduction in pore size. This reduction is likely due to surface tension effects introduced by CNTs in the polymer slurry, which alter the kinetics of the phase separation process.

When combined with lithium metal and paired with an LFP cathode under 1C/1C cycling conditions, the CNT-modified porous film exhibits comparable initial capacity retention relative to the unmodified DW5 film. However, with continued cycling, the CNT-modified film shows accelerated capacity degradation and ultimately experiences premature failure (FIG. 8C and FIG. 8D). This performance decline is attributed to the high electrical conductivity of CNTs, which promote preferential lithium deposition on the external surface of the porous film rather than facilitating uniform lithium growth within its internal porous network. This surface-biased lithium plating leads to the formation of isolated lithium clusters—commonly referred to as “dead lithium”—which not only increase electrolyte consumption but also elevate the risk of internal short circuits, thereby compromising long-term cycling stability.

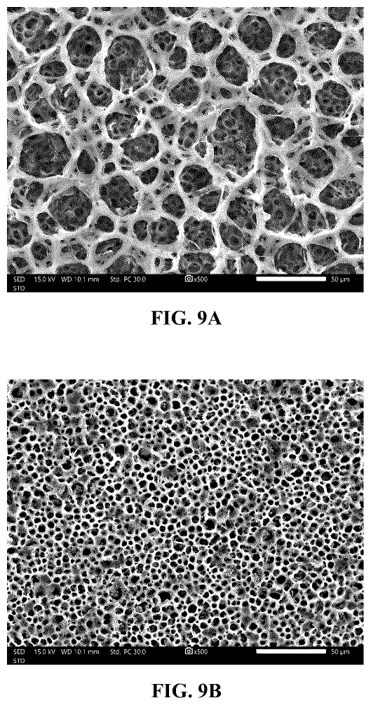

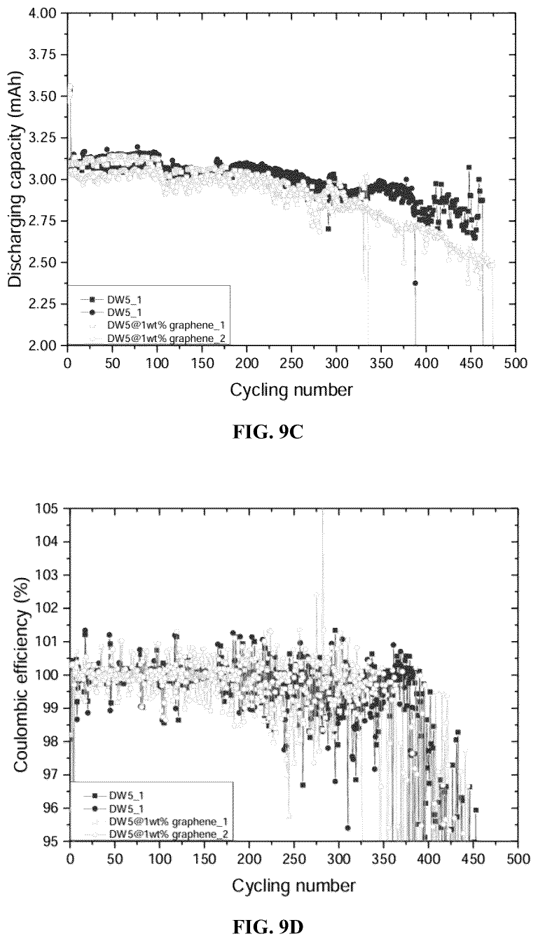

Graphene is also assessed as an additive in porous film fabrication. A polymer slurry containing 1 wt % graphene is cast into a porous membrane with a thickness of approximately 40 μm using the DW5-derived methodology. The incorporation of graphene also leads to distinct morphological modifications. As shown in FIG. 9A and FIG. 9B, both the top and bottom surfaces of the graphene-containing membrane exhibit pore structures generally similar to those of the DW5 reference film. However, the pore sizes are more uneven and heterogeneous, likely due to the surface tension effects introduced by graphene sheets, which alter the local thermodynamics and dynamics of the phase separation process.

When composited with lithium metal and paired with an LFP cathode under 1C/1C cycling conditions, the graphene-modified porous film exhibits initial capacity retention comparable to that of the unmodified DW5 reference film (FIG. 9C and FIG. 9D). The similar cycling behavior may be attributed to the limited dispersion and insufficient formation of a continuous conductive network by the graphene additive. As a result, key bulk properties of the porous film—such as ionic conductivity, pore structure, and tortuosity—remain largely unchanged compared to the original DW5 formulation, thereby producing no significant enhancement or degradation in electrochemical performance.

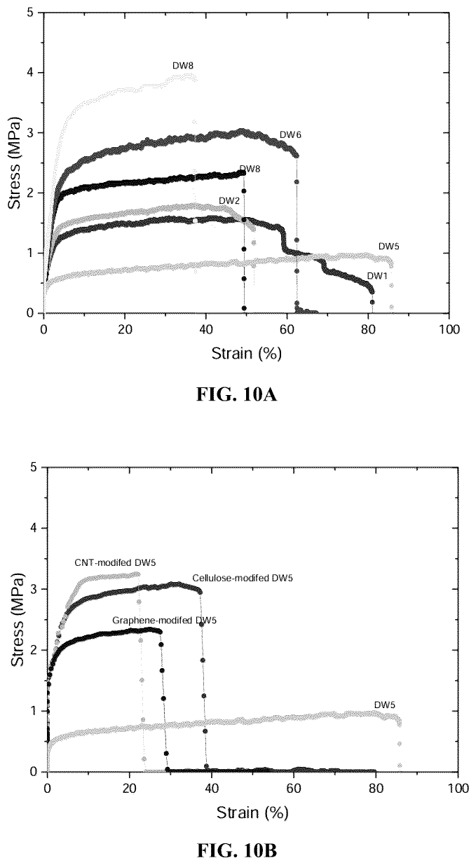

As shown in FIG. 10A and FIG. 10B, the mechanical strength of the porous polymer films is influenced by both the polymer concentration and the specific fabrication conditions employed. Films prepared with higher concentrations of PVDF-HFP—such as DW4 and DW8—exhibit superior mechanical integrity, which can be attributed to reduced porosity resulting from the higher polymer content. Additionally, increasing the temperature of the polymer slurry during the casting process contributes to improved mechanical strength, likely due to enhanced polymer chain entanglement and tighter molecular packing. In contrast, films cast on PE substrates show noticeably lower mechanical strength. This is attributed to the strong hydrophobic nature of PE, which promotes more aggressive pore formation during the phase separation process, leading to a more porous and mechanically fragile structure.

Among the formulations tested, the DW5 film achieves the highest porosity, which facilitates more uniform lithium deposition within the internal pore network. However, this increased porosity also correlates with relatively lower mechanical robustness. To address this, the mechanical strength of the DW5-based porous films is subsequently enhanced by incorporating reinforcing additives, demonstrating a viable strategy for optimizing the balance between porosity and structural integrity.

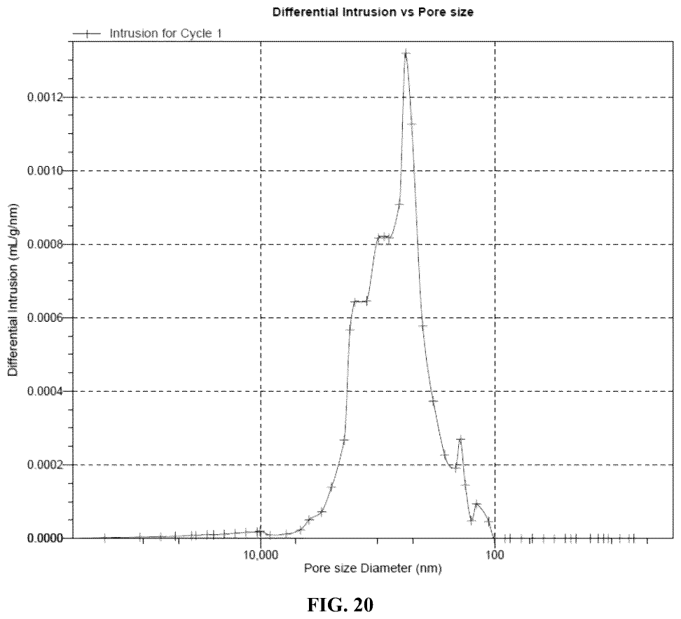

Additionally, as shown in FIG. 20, the results of mercury intrusion porosimetry further show that the pore size of the porous DW5 film ranges from about 100 nm to about 40 microns.

### Example 3. Performance of Lithium Metal Batteries Incorporating Cycling Performance-enhancing Porous Polymer Films

Coin cell batteries are fabricated to evaluate the cycling performance of lithium metal anodes with and without the application of the cycling performance-enhancing porous polymer film. In each coin cell, the cathode material employed is lithium iron phosphate (LFP), providing an areal capacity of approximately 3.1 mAh/cm², consistent with industrially relevant high-capacity cathodes. The separator utilized is a standard polyolefin-based membrane (Celgard 2400). For cells without the porous film, the negative electrode consists of a commercial lithium-copper composite tape, including a 50 μm thick lithium layer laminated onto a copper current collector.

In the experimental group, the porous polymer film is positioned directly on the lithium metal surface such that the top surface of the film—characterized by a coarser and more open pore structure—faced the lithium metal, while the bottom surface—featuring finer and more uniform pores—faces the separator. The electrolyte used in all cases is a 3 M solution of lithium bis(fluorosulfonyl)imide (LiFSI) in dimethoxyethane (DME), added at a volume of 40 μL per coin cell.

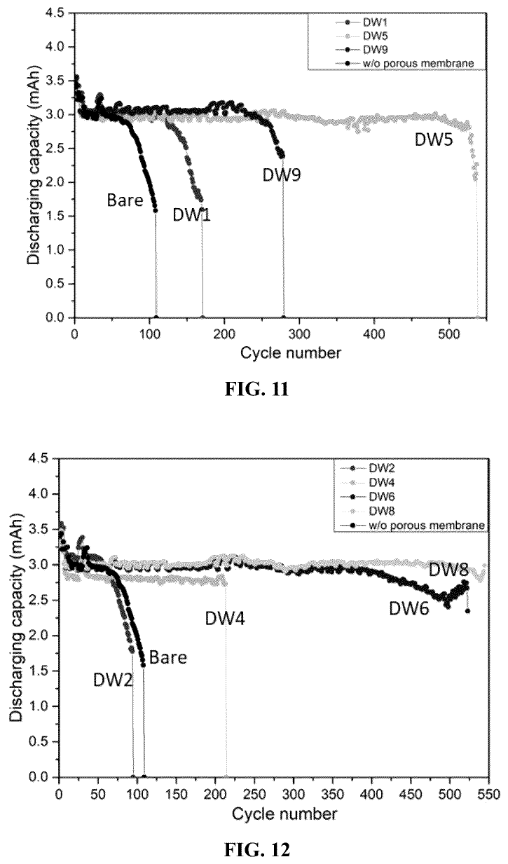

FIG. 11 displays the cycling performance of coin cells comparing bare lithium anodes with lithium anodes modified with porous films cast from polymer solutions at room temperature (designated DW1, DW5, and DW9). The data clearly demonstrate the beneficial impact of incorporating the porous film. Cells with bare lithium anodes fail after approximately 100 cycles due to capacity degradation. In contrast, all porous film-modified anodes extend battery life significantly. Among them, DW5 exhibits the best performance, sustaining over 500 cycles at a 1C charge-discharge rate while maintaining more than 90% of the initial discharge capacity. Notably, DW5 also possesses the lowest Gurley value of the tested samples, indicating higher gas permeability, which appears correlated with superior cycling stability. These results suggest that a low Gurley value—indicative of an open and efficient porous structure—contributes favorably to battery durability.

FIG. 12 shows similar experiments performed with porous films cast from polymer solutions at 60° C. (samples DW2, DW4, DW6, and DW8). With the exception of DW2, all porous film-modified cells outperform the bare lithium configuration. Although all samples display similar Gurley values, DW6 and DW8 again demonstrate superior stability, achieving 500 cycles. By contrast, DW4 supports cycling only slightly beyond 200 cycles before failure, while DW2 fails to show meaningful improvement. The performance discrepancies among films with comparable permeability suggest that other factors—such as casting substrate—also influence performance. DW5 (FIG. 11), DW6, and DW8 are all cast using PE substrates, which appears to positively affect film morphology and lithium interface compatibility. This result highlights the importance of substrate selection in the fabrication of the porous films.

To further investigate how the porous film influences lithium deposition morphology, in-situ visualization techniques are employed using a Lasertec ECCS Electrochemical Confocal System. This analysis compares lithium metal deposition behavior in the absence and presence of the DW5 porous film.

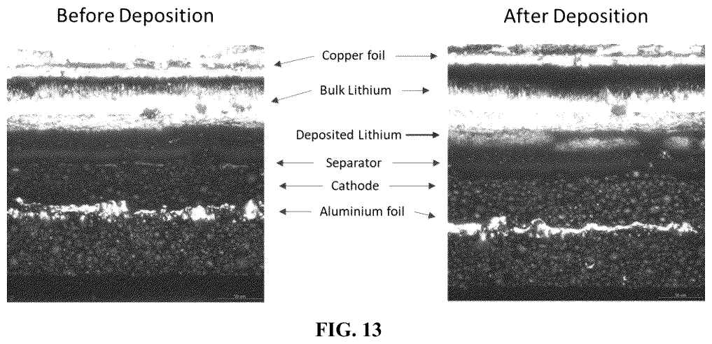

FIG. 13 presents before-and-after images of a coin cell with a bare lithium anode. The cell structure consists of a lithium foil laminated on a copper current collector, followed by the separator (Celgard 2400) and a cathode having NCM811 material coated on an aluminum foil. Upon charging, lithium ions are reduced and deposited onto the surface of the lithium metal. After deposition, the newly formed lithium appears as a porous layer made up of fine particulates. This loosely packed structure is typically unstable and associated with reduced coulombic efficiency, greater formation of “dead lithium,” and limited cycle life.

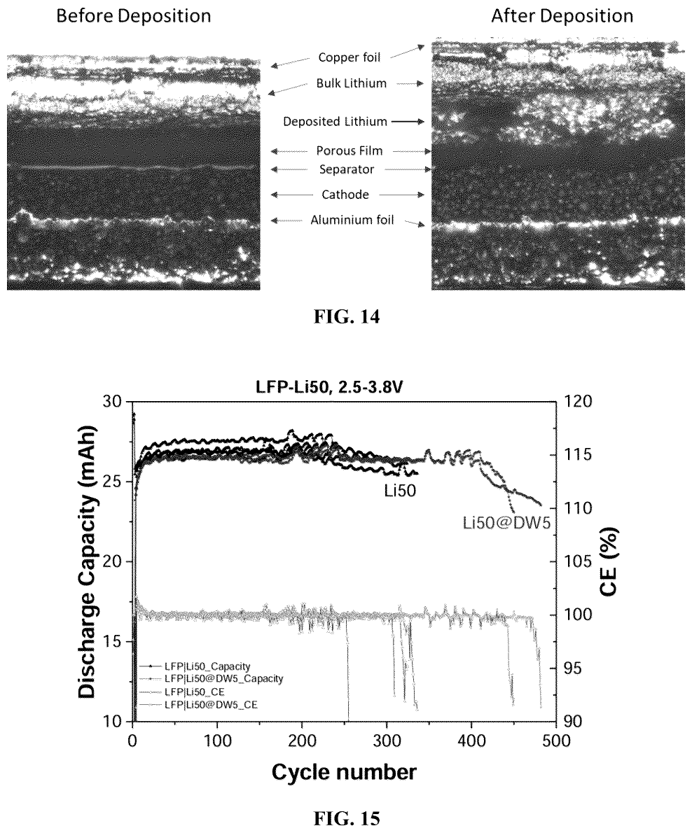

In contrast, FIG. 14 shows the result of a similar experiment with the DW5 porous film positioned between the lithium surface and separator. In this configuration, the deposited lithium layer adopts a dense and cohesive morphology, more closely resembling the underlying bulk lithium. This homogenous and compact deposition profile is known to improve cycling stability by mitigating dendrite formation and reducing interfacial resistance. The visual evidence provided in FIG. 10 confirms the role of the DW5 porous film in guiding favorable lithium deposition and reinforces the performance advantages observed in the electrochemical cycling data.

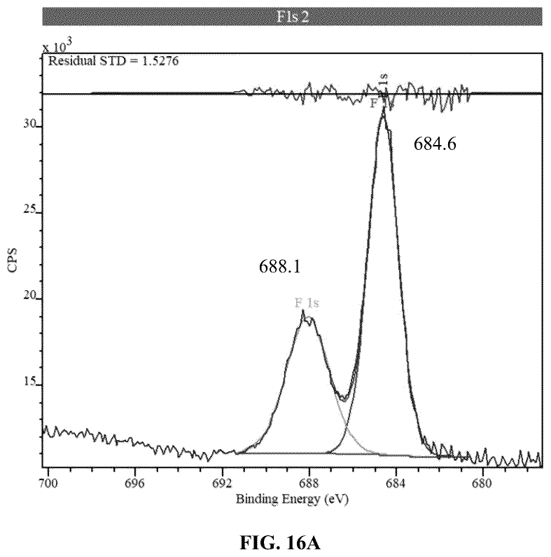

Additionally, pouch cells are fabricated to evaluate the cycling performance of lithium metal anodes under more practical conditions. A DW5 porous film is integrated with a lithium metal foil (50 μm thickness) to serve as the anode in single-layer pouch cell testing. This configuration is compared against a control pouch cell utilizing a bare lithium metal anode without the porous film. Both cells employ a LFP cathode with an areal capacity of 3.2 mAh/cm² and are cycled between 2.5 V and 3.8 V at a 1C charge/discharge rate. As shown in FIG. 15, the control cell with bare lithium exhibits a sharp decline in coulombic efficiency after approximately 300 cycles, indicating the onset of micro short circuits that ultimately led to battery failure. In contrast, the pouch cell incorporating the DW5 porous film demonstrates significantly improved stability, maintaining high coulombic efficiency and stable cycling for over 400 cycles. This result demonstrates that the DW5 film effectively promotes uniform lithium deposition and mitigates the formation of short-circuit-inducing structures, such as dendrites.

Post-mortem analysis is performed on the pouch cell with the bare lithium anode. After cell disassembly and drying, it is observed that the electrolyte has been fully consumed. Inspection of the ceramic-coated side of the separator reveals numerous black spots, some of which cannot be detached, strongly suggesting the formation and penetration of lithium dendrites through the separator, leading to overcharging and reduced coulombic efficiency. On the polymer-coated side, dense and thick lithium deposits are found adhered to the separator, with visible intrusion of lithium into the separator matrix. Meanwhile, the lithium metal on the anode side is completely depleted. The remaining lithium appears fragile and exhibited poor adhesion, easily peeling off during handling. These combined observations indicate severe dendritic growth, electrolyte depletion, and lithium loss—all contributing factors to cell degradation and eventual failure.

In contrast, the post-mortem examination of the pouch cell employing the DW5 porous film-modified lithium anode shows improved structural integrity and electrochemical behavior. After drying, the cell also exhibits full electrolyte consumption. However, the ceramic side of the separator displays fewer and less pronounced black spots, while the polymer side reveals considerably reduced lithium deposition compared to the bare lithium cell. The DW5 porous film remains uniformly intact on the anode surface and is visibly infused with deposited lithium, indicating that the film effectively guides uniform lithium plating during cycling. Upon removal of the separator, only a minimal amount of lithium residue is found on the copper current collector. These results suggest that the porous film facilitates more efficient lithium utilization, reduces irreversible lithium loss, and significantly mitigates dendrite formation—contributing to longer cell life and improved safety.

### Example 4. Performance of the Cycling Performance-enhancing Porous Polymer Films in Trapping SEI Components

To evaluate the ability of the porous polymer film to trap SEI materials for reuse in subsequent cycles—and thereby enhance cycling performance—a comparative experiment is conducted.

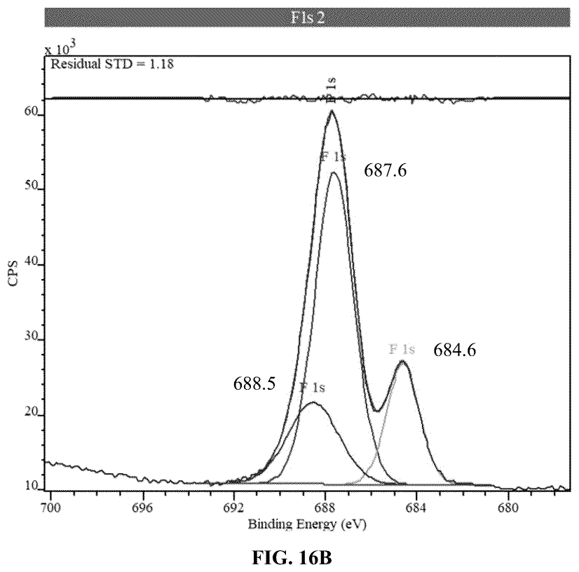

Lithium deposition and stripping are first performed on a bare Cu foil in a full-cell configuration, paired with a 3.2 mAh/cm² cathode and using 3M LiFSI in DME as the electrolyte. The cell is cycled for 10 cycles, ending with lithium stripping. At this point, only the residual native SEI components remain on the Cu surface, which are characterized via XPS (FIG. 16A) and used as a control reference.

In the test group, a DW5 porous polymer film is placed on the Cu foil and subjected to the same lithium deposition/stripping procedure. After the final stripping cycle, the porous film is carefully removed from the Cu foil, leaving behind any residues not retained by the film. XPS analysis is then performed on the Cu foil surface (FIG. 16B). By comparing the XPS spectra of this sample with the control, the SEI materials that have been captured and removed by the porous film can be inferred.

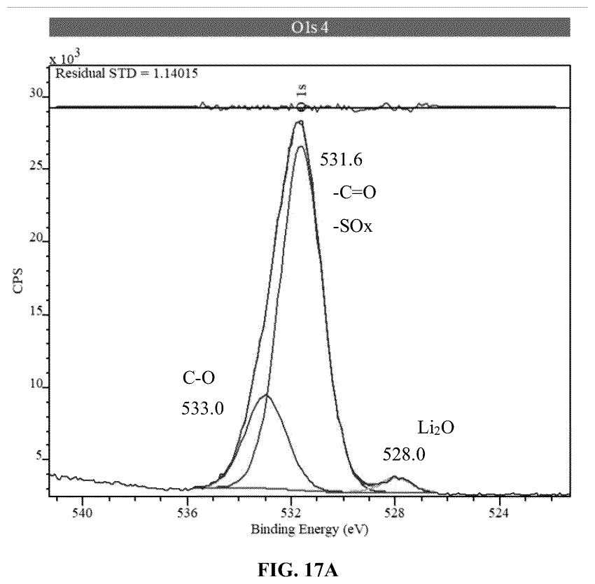

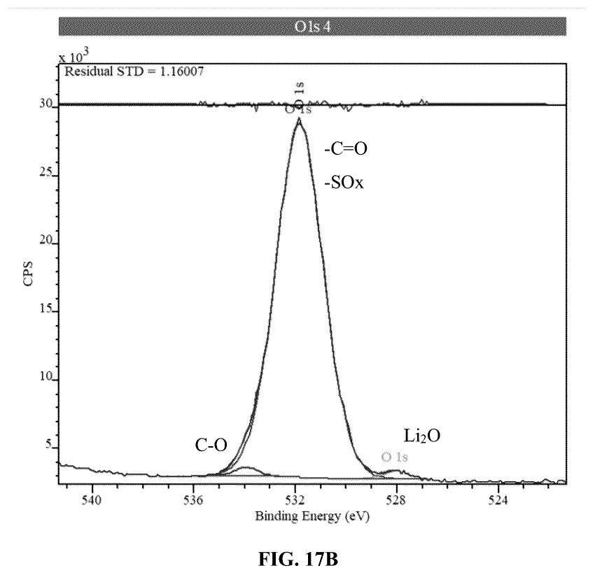

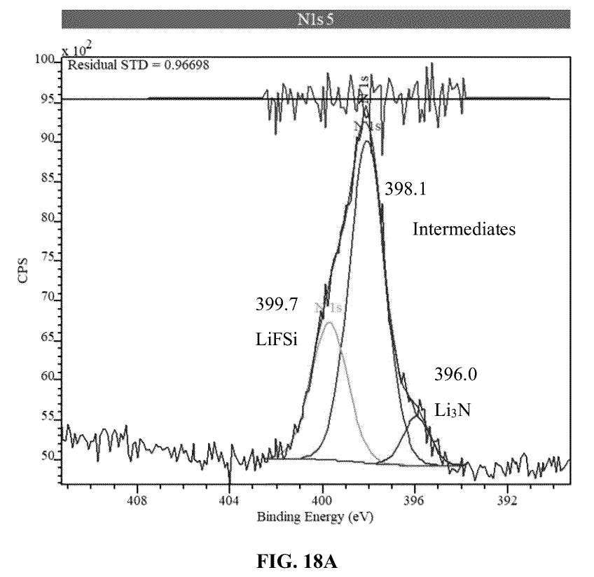

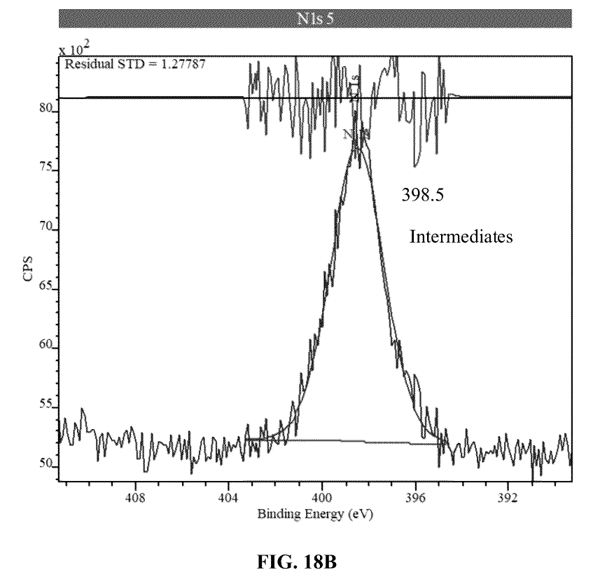

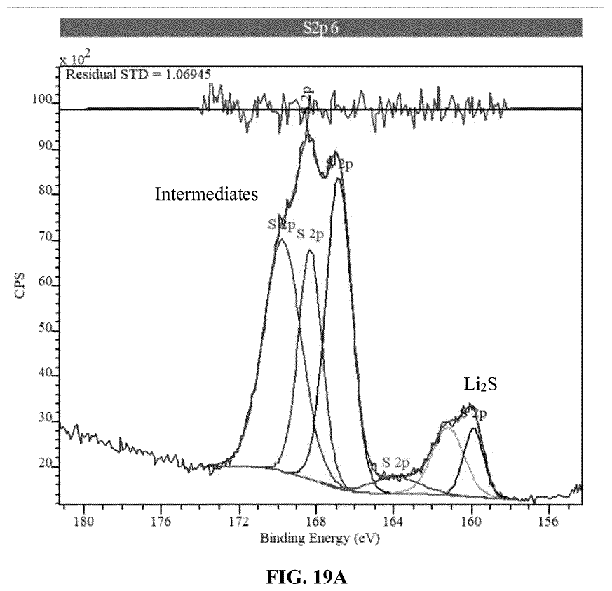

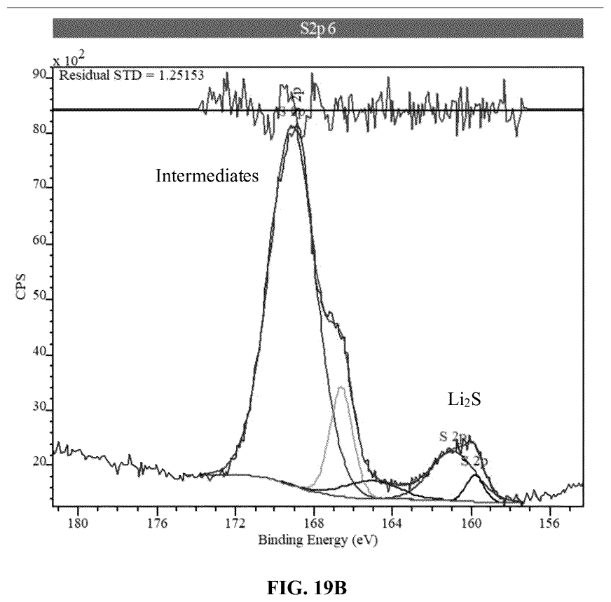

Particular attention is given to SEI components originating from the decomposition of LiFSI, which typically include fluorine (F), oxygen (O), nitrogen (N), and sulfur (S)-based species. In the F 1s spectrum (FIGS. 16A-16B), a stronger signal is observed on the Cu foil beneath the porous film compared to the control, likely due to residual PVDF-HFP from the DW5 film. However, in the O 1s (FIGS. 17A-17B), N 1s (FIGS. 18A-18B), and S 2p (FIGS. 19A-19B) spectra—which reflect decomposition products of LiFSI—the control Cu foil exhibits a rich presence of such SEI compounds. In contrast, these signals are largely absent on the Cu foil that has been covered by the porous film during cycling.

This difference strongly suggests that the porous film effectively traps and removes a significant portion of the SEI materials during cycling. Consequently, these SEI components are not detected on the Cu foil surface post-stripping, having been extracted along with the porous film prior to XPS analysis. This experiment evidences that the porous polymer film captures SEI intermediates for potential reuse, thereby contributing to enhanced cycling stability and reduced irreversible capacity loss.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A rechargeable lithium metal battery, comprising:
a lithium metal negative electrode;
a cycling performance-enhancing porous polymer film disposed on the lithium metal negative electrode, the cycling performance-enhancing porous polymer film comprising polar functional groups and having:
pores having an average diameter ranging from 100 nm to 40 microns;
a porosity between 50% and 90%,
a thickness between 10 μm and 100 μm,
a Gurley value lower than 30 s/100 cc, and
a tensile strength between 0.5 MPa and 5 MPa;
a separator;
an electrolyte; and
a positive electrode;
wherein the cycling performance-enhancing porous polymer film is configured to trap detached or dislodged components of the solid electrolyte interphase (SEI) that form during battery cycling, and to retain these components within its porous structure for potential reincorporation into the SEI during subsequent charge-discharge cycles, thereby enhancing SEI stability and improving cycling performance;
wherein the battery retains at least 90% of discharge capacity after at least 500 charge-discharge cycles at a rate of 1C.

2. The rechargeable lithium metal battery of claim 1, wherein the porous polymer film comprises one or more of polyvinylidene difluoride (PVDF), poly(vinylidene fluoride-co-hexafluoropropylene) (PVDF-HFP), copolymers of polyacrylonitrile (PAN), polyacrylate copolymers, polystyrene copolymers, polymethyl methacrylate (PMMA) copolymers, polyvinylpyrrolidone (PVP) and its copolymers, polyetherimide (PEI) and its copolymers, polysulfone and its copolymers, polyimide (PI) and its copolymers, polyphenylene sulfide (PPS), polyether sulfone (PES) and its copolymers, polydimethylsiloxane (PDMS) and its copolymers, cellulose acetate (CA), or cellulose.

3. The rechargeable lithium metal battery of claim 2, wherein the cycling performance-enhancing porous polymer film further comprises an additive selected from one or more of carbon nanotubes, vapor-grown carbon fibers, graphene, metal-organic frameworks (MOFs), and conducting polymers.

4. The rechargeable lithium metal battery of claim 3, wherein the MOF is selected from MOF-808, MOP-17, UiO-66, ZIF-8, ZIF-67, or HKUST-1.

5. The rechargeable lithium metal battery of claim 3, wherein the conducting polymer is selected from polyaniline (PANI), polypyrrole (PPY), polythiophene, or poly(3,4-ethylenedioxythiophene) (PEDOT).

6. The rechargeable lithium metal battery of claim 1, wherein the lithium metal negative electrode comprises a lithium metal foil laminated on a copper current collector.

7. The rechargeable lithium metal battery of claim 6, wherein the lithium metal foil has a thickness of 50 μm or less.

8. The rechargeable lithium metal battery of claim 1, wherein the positive electrode includes one or more of lithium iron phosphate, lithium cobalt oxide, lithium nickel cobalt manganese oxide, lithium nickel cobalt aluminum oxide, spinel type lithium manganese oxide, or spinel type lithium nickel manganese oxide.

9. The rechargeable lithium metal battery of claim 1, further comprising a separator disposed between the negative electrode and the positive electrode.

10. The rechargeable lithium metal battery of claim 1, wherein the cycling performance-enhancing porous polymer film promotes uniform lithium-ion flux across the electrode surface and mitigates dendritic lithium growth during repeated cycling.

11. The rechargeable lithium metal battery of claim 1, wherein the trapped detached or dislodged components of the SEI are re-integrated into the SEI layer during subsequent lithiation/delithiation cycles.

12. A method of fabricating the rechargeable lithium metal battery of claim 1, comprising:
forming the cycling performance-enhancing porous film by a phase separation technique followed by subsequent drying;
laminating the cycling performance-enhancing porous polymer film onto the lithium metal negative electrode; and
assembling the negative electrode, positive electrode, separator, and electrolyte to form the rechargeable lithium metal battery.

13. The method of claim 12, wherein the phase separation technique includes depositing a polymer film by depositing a polymer solution onto a substrate followed by immersion into a bath that includes a polymer solvent and a polymer non-solvent.

14. The method of claim 13, wherein the polymer solution has a concentration ranging from 5% to 30%.

15. The method of claim 13, wherein the solvent is selected from one or more of acetone, chloroform, tetrahydrofuran (THF), dimethylformamide (DMF), dimethylacetamide (DMAc), N-Methyl pyrrolidone (NMP), dimethyl sulfoxide (DMSO); and the non-solvent is selected from one or more of deionized water, ethanol, methanol, glycerin, glycerol, butanol, hexanol, or octanol.

16. The method of claim 13, wherein the wet thickness of the deposited polymer solution on the substrate is 50 to 300 μm.

17. The method of claim 13, wherein the casting temperature of forming the cycling performance-enhancing porous film ranges from 25° C. to 80° C.

18. The method of claim 13, wherein the substrate deposited with the polymer film is exposed at room temperature for 5 minutes to 60 minutes before the immersion.

19. The method of claim 12, wherein the immersion time ranges from 1 hour to 24 hours.

20. The method of claim 12, wherein the substrate is a glass plate, polyethylene terephthalate (PET) film, polyethylene (PE) film, polypropylene (PP) film, or polytetrafluoroethylene (PTFE) film.
